(19) United States
(12) Patent Application Publication
(10) Pub. No.: US 2013/0308771 A1
(43) Pub. Date: Nov. 21, 2013

(54) METHOD AND APPARATUS FOR HIERARCHICAL ADAPTIVE FILTER

(71) Applicants: Mark Raifel, Ra'anana (IL); Yaakov Chen, Rishon Le-tzion (IL); Amos Schreibman, Kfar Saba (IL); Eli Fogel, Herzliya (IL)

(72) Inventors: Mark Raifel, Ra'anana (IL); Yaakov Chen, Rishon Le-tzion (IL); Amos Schreibman, Kfar Saba (IL); Eli Fogel, Herzliya (IL)

(73) Assignee: DSP Group Ltd, Herzliya (IL)

(21) Appl. No.: 13/982,276

(22) PCT Filed: Feb. 3, 2011
(86) PCT No.: PCT/IL11/00125

§ 371 Date: Jul. 29, 2013

(51) Int. Cl. H04M 3/00

(52) U.S. Cl. CPC H04M 3/002
USPC 379/406.01

(57) ABSTRACT

A method and apparatus for filtering a reference signal by a series of taps having coefficients, comprising dividing the taps into at least one layer of a plurality of groups, each group comprising a plurality of taps, as a first layer, forming a plurality of coefficients arranged in at least one group, as at least one subsequent layer and forwarding multiply-accumulate results of each group in each layer sequentially to the at least one group in the at least one subsequent layer to generate an output signal, and adjusting the coefficients based on an error signal formed as a difference between the output signal and a received input signal related to the reference signal and an interim error signal as a difference between the input signal and a summation of the multiply-accumulate results of at least one layer.

### BACKGROUND

The present disclosure relates to an adaptive signal processing in general, and to a hierarchical adaptive filtering in particular.

Adaptive processors are used for approximating signals, for purposes such as approximating undesired signals in order to cancel them.

Referring now to FIG. 1, showing a general usage of an adaptive processor.

x(k) (104) is a reference or input signal, wherein k is the time index. d(k) (108) is a signal associated with x(k), which may sometimes be a parasitic signal.

For example, x(k) may be voice to be transmitted over a telephone line, and d(k) can be an echo of x(k), which should be cancelled and not transmitted. Thus, adaptive processor 116 is aimed at attempting to generate a signal y(k) (120) which is based on x(k) (104) and is as similar as possible to d(k) (108). w(k) can be a stationary background noise or non-stationary interference like speech signal. d(k) (108) and w(k) are summed by adder 110 to generate s(k) (114). In the ideal case in which the estimated signal y(k) (120) is equal to d(k) (108), d(k) (108) and y(k) (112) will cancel each other at adder 124, leaving only w(k) (112) signal to be output. e(k) (128), which in the optimal case is equal to w(k) (112) is output and returned as a control feedback to adaptive processor 116, for adjusting the processor's parameters in order to minimize the error signal under a certain criteria, such as mean squared error (MSE), least squares (LS), mean absolute error (MAE) or others.

Adaptive processors can be used for applications such as but not limited to: adaptive prediction, system identification, control, echo cancellation, equalization, interference cancellation, noise cancellation, noise reduction, or the like.

A number of algorithms for approximating the adaptive processor parameters are known, such as least-mean squares (LMS), normalized LMS (NLMS), proportionate NLMS (PNLMS), block NLMS (BNLMS), multi-delay adaptive filtering (MDAF), recursive least squares (RLS), fast RLS (FRLS) or extensions thereof.

The performance of adaptive processor may relate to any one or more parameters, such as but not limited to: convergence rate; misadjustment level in convergence, that is, the distance between the error signal e(k) and the w(k) signal when complete convergence is achieved; adaptation robustness to noise signal w(k) (112); or re-convergence rate, that is, the ability to track changes of the transfer function between the reference signal x(k) and desired signal d(k), and to readjust the adaptive processor.

### SUMMARY

An exemplary embodiment of the disclosed subject matter is a method for filtering a reference signal by a series of taps having coefficients, comprising dividing the taps into at least one layer of a plurality of groups, each group comprising a plurality of taps, as a first layer, forming a plurality of coefficients arranged in at least one group, as at least one subsequent layer and forwarding multiply-accumulate results of each group in each layer sequentially to the at least one group in the at least one subsequent layer to generate an output signal. Optionally, the method further comprises adjusting the coefficients based on an error signal formed as a difference between the output signal and a received input signal related to the reference signal and an interim error signal as a difference between the input signal and a summation of the multiply-accumulate results of at least one layer. Further optionally, the error signal and the interim error signal are weighted for adjusting the coefficients.

Another exemplary embodiment of the disclosed subject matter is an electronic apparatus adapted to carry out the method disclosed above, at least partially. Optionally, the electronic apparatus comprises a processor operable according to a program stored in a computer-readable medium.

In the context of some embodiments the present disclosure related to a Finite Input Response (FIR) a ‘tap’ is generally a construct or a formation of a time-delayed data sample of a signal and a corresponding coefficient as a weight of the sample.

In the context of some embodiments the present disclosure a ‘Multiply-Accumulate’ (MAC) is generally the operation of multiplying a plurality of a data values by corresponding coefficients and accumulating the results.

In the context of some embodiments the present disclosure and without limiting, a ‘steady-state’ is a state of a filter, such as in terms of signal samples or values if coefficients, that is stable within given margins under given circumstances.

### BRIEF DESCRIPTION OF THE DRAWINGS

Some non-limiting exemplary embodiments of the invention are illustrated in the following drawings.

Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described.

For convenience or clarity, some elements or structures are not shown or shown only partially and/or with different perspective or from different point of views.

FIG. 1 is a schematic illustration of a circuit using an adaptive processor;

FIG. 2 is a schematic illustration of prior art adaptive filter;

FIG. 3A schematically illustrates a hierarchy of multiple-stage filter, in accordance with the disclosure;

FIG. 3B is a schematic illustration of a hierarchical adaptive filter, in accordance with the disclosure;

FIG. 3C is a schematic illustration of a hierarchical adaptive filter with weighted error feed back, in accordance with the disclosure;

FIG. 4A is a flowchart outlining operations for a hierarchical adaptive processor, in accordance with the disclosure;

FIG. 4B is a flowchart of operations in the method for implementing an adaptive processor, in accordance with the disclosure;

FIG. 5A illustrates an echo path as a sparse impulse response;

FIG. 5B illustrates simulation of convergence and tracking of a hierarchical adaptive filter with weighted error feed back in the case of white Gaussian noise as related to the response of FIG. 5A, in accordance with the disclosure; and

FIG. 5C illustrates the weights distribution of a second stage of a hierarchical adaptive filter with weighted error feed back in a steady state, in accordance with the disclosure.

### DETAILED DESCRIPTION

For demonstration purposes only and without limiting the generality of the proposed apparatus and methods, the disclosure considers a filter of finite impulse response in general and a normalized least-mean squares (NLMS) method in particular, without precluding apparatus and methods such as least-mean squares (LMS), normalized LMS (NLMS), proportionate NLMS (PNLMS), block NLMS (BNLMS), multi-delay adaptive filtering (MDAF), recursive least squares (RLS), fast RLS (FRLS) or extensions or combinations thereof.

For brevity and clarity and without limiting, in the present disclosure relating to a filter or a processor implies an apparatus comprising an electronic circuitry and/or a medium storing a program executable by a processor and configured to carry out a FIR filtering method such as an adaptive filtering.

A technical problem dealt with by the disclosed subject matter is a improving the performance of an adaptive filter relative to methods known in the art, in terms such as convergence rate, misadjustment level in convergence, adaptation robustness to noise signal or re-convergence rate.

A technical solution comprises dividing the taps having first coefficients into a plurality of groups, each group comprising a plurality of taps, as a first layer, forming a plurality of second coefficients arranged in at least one group, as at least one subsequent layer, forwarding multiply-accumulate results of each group in each layer sequentially to the at least one group in the at least one subsequent layer thereby generating an output signal, and adjusting the first coefficients and the second coefficients based on an error signal formed as a difference between the output signal and a received input signal that comprises a signal related to the reference signal and an interference.

The technical solution further comprises, in some embodiments, adjusting the first coefficients and second coefficients based on the error signal and an at least one interim error signal formed as a difference between the received input signal and a summation of the multiply-accumulate results of at least one layer.

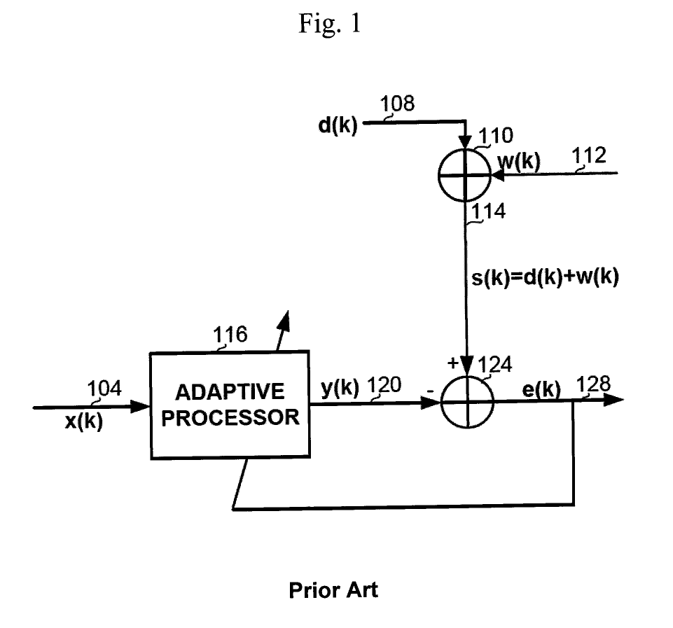

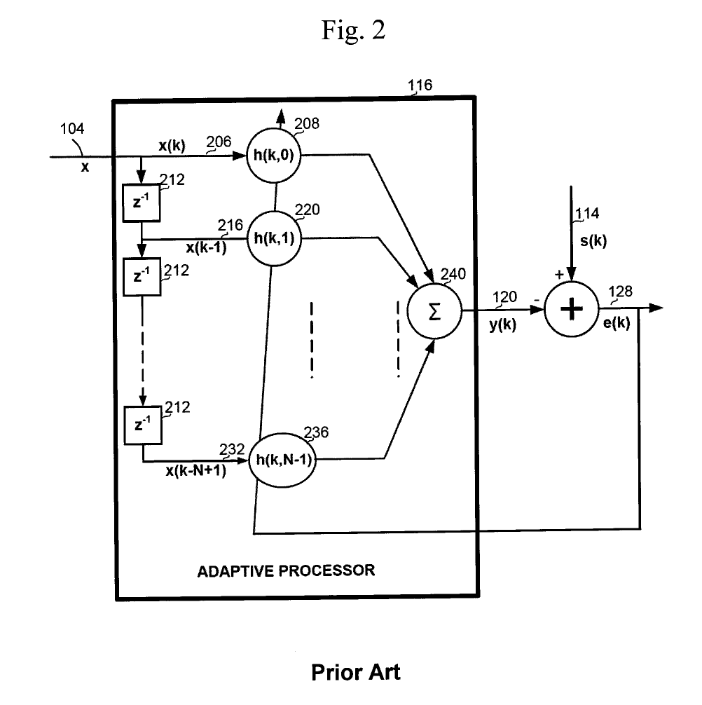

A reference is made to FIG. 1 that schematically illustrates a circuit using an adaptive processor, and to FIG. 2 that schematically illustrates an adaptive filter as known in the art.

Input signal x (104) at a given time index k is successively sampled with a time delay 212 for a range of N consecutive samples n where n=0 . . . N−1, providing samples x(k−n) where x(k,0) is the current sample and x(k−(N−1)) is the oldest sample in time within the range of N samples. For example, x(k) (206), a preceding delayed sample x(k−1) (216), and so on until x(k−N+1) (232).

For each sample x(k−n) is determined a coefficient h(k,n), as h(k,0) (208), h(k,1) (220) . . . h(k,N−1) (236). Each sample x(k−n) is multiplied by the corresponding coefficient h(k,n), and the products are summed by adder 240 to provide an output signal y(k) (120) as:

$$y ( k ) = {\sum }_{n = 0}^{N - 1} h ( k , n ) x ( k - n ) . \qquad ( Eq . 1 )$$

An error signal, e(k) (128), is determined as:

e(k)=s(k)−y(k). (Eq. 2)

The total energy of the k′th time index is defined as:

$${σ}_{x}^{2} ( k ) = \frac{1}{N} {\sum }_{n = 0}^{N - 1} {x}^{2} ( k - n ) . \qquad ( Eq . 3 )$$

For NLMS method the coefficients h(k,n) are determined as follows:

$$h ( 0 , n ) = 0 ; \\ h ( k + 1 , n ) = h ( k , n ) + \frac{μ e ( k ) x ( k - n )}{N {σ}_{x}^{2} ( k ) + β} \qquad ( Eq . 4 )$$

Wherein:

μ is a constant, ranging between about 0 and about 2, representing a step size or the learning or adaptation pace, and

β is a regularization factor as a small constant, such as 0.01, for avoiding a division by zero where the input signal x is zero.

It is noted that the value of μ is constant as an example, and does not reflect values to be used in other contexts.

In some cases there is a tradeoff between different performance parameters such as convergence rate, misadjustment level in convergence, adaptation robustness to noise signal or re-convergence rate. For example, the lower μ is, the slower is the system convergence rate and smaller is the misadjustment levels, and vice versa. Some extensions of the NLMS method attempt to outperform NLMS in one or more of the performance measures, while keeping the other measures intact, by using the same step size μ for the various methods so that the measures are comparable. For example, in “Proportionate normalized least mean square adaptation in echo cancellers” by D. L. Duttweiler, published on IEEE Trans. Speech Audio Processing, vol. 8, pp. 508-518, September 2000, a proportionate NLMS algorithm is proposed in order to increase the convergence rate of the NLMS algorithm by keeping the convergence level intact, yet, although the convergence rate is increased the misadjustment level is increased as well.

In an endeavor to improve the performance of an adaptive filter relative to other filters such an NLMS by increasing the convergence rate while decreasing the misadjustment level, or at least not increasing the misadjustment level, a hierarchical scheme was conceived and devised, examples of which are described below.

In some embodiments, the scheme comprises dividing the filtering into consecutive stages, each consecutive stage processes partial results of a preceding stage, where the partial results are optionally a plurality of sums of weighted signals.

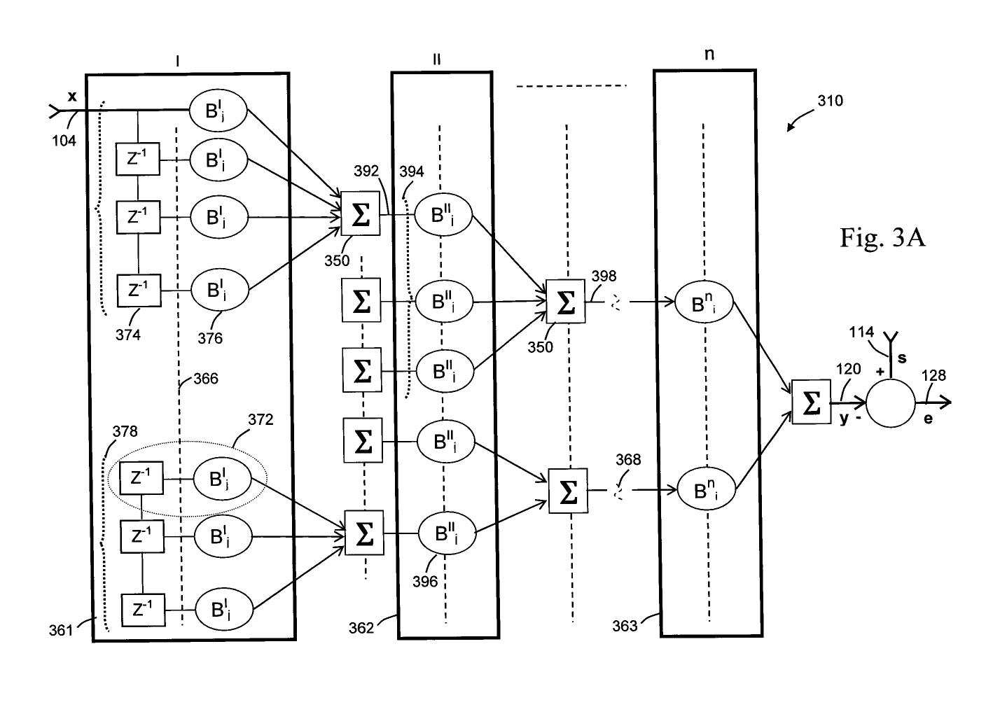

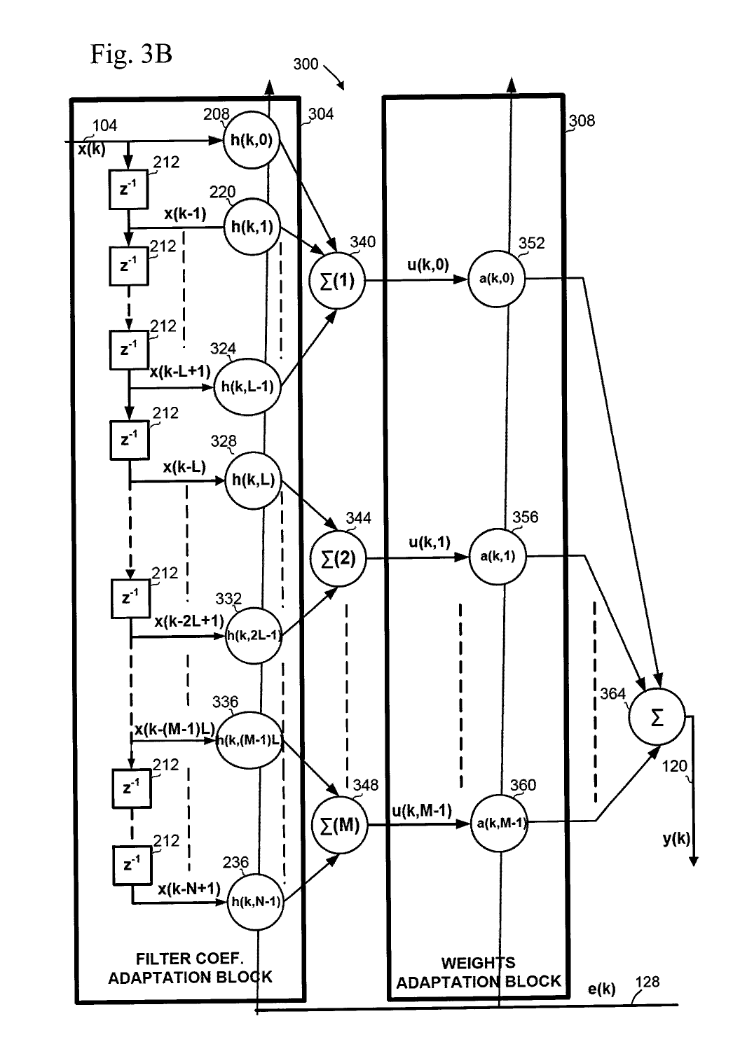

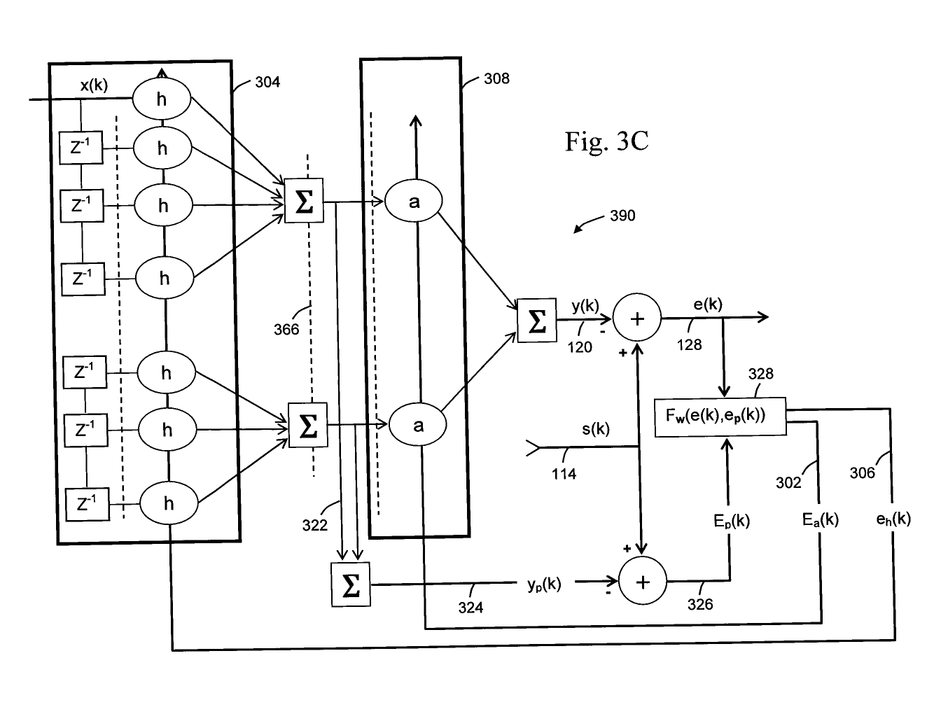

FIG. 3A schematically illustrates a hierarchy of multiple-stage filter as filter 310, in accordance with the disclosure.

A reference signal 104 denoted as x is sampled sequentially with time delay and formed in a first layer 361, denoted as I, as a plurality of tap 372 as denoted by the dotted oval, where a nil-time delay is considered as a delay for brevity and without limiting. The taps are, for example, as known in the art, and formed as pairs of a delayed sample 374 and a corresponding coefficient 376.

The taps are structured in a plurality of groups, a group denoted as group 378 as indicated by the dotted bracket, each group comprises a plurality of tap 372, though, in some embodiments, a group may include one instance of tap 372.

In some embodiments, a multiply-accumulate (MAC) operation is performed on the taps of each group 378, yielding a plurality of interim or intermediate signal 392 corresponding to the plurality of group 378, where the accumulate operation, or accumulator, is denoted by Σ symbol as 390.

In some embodiments, the plurality of intermediate signal 392 are fed, or forwarded, to a subsequent layer 362, denoted as II, where the plurality of intermediate signal 392 are divided to a plurality of separate set or group 394, each group 394 comprises a plurality of intermediate signal 392, though in some embodiments a set includes one intermediate signal 392. The intermediate signals in each set are multiplied by a plurality of corresponding coefficient 396 and are accumulated by accumulator 350, akin or similar or equivalently to a multiply-accumulate operations on the plurality of tap 372, yielding one or more intermediate signal 398.

In some embodiments, the operations on subsequent layers as described above are repeated for each subsequent layer up to a final layer 363, denoted as n that yield an output signal 120, denoted as y. Repeated pluralities of elements are denoted by dashed lines such as line 366 or separator as separator 368.

In some embodiments, a difference as an error signal 128, denoted as e, between output signal 120 and an input signal 114, denoted as s, is obtained.

In some embodiments, error signal 128 is fed back (not shown) to one or more of the layers, adjusting respective coefficients such as the plurality of coefficient 376 or the plurality of coefficient 396, thereby altering or adapting the output signal 120 such as reducing the error signal 128.

In some embodiments, one or more of sums (not shown) of a plurality of intermediate results, such as the plurality of intermediate signal 392 or one or more intermediate signal 398, is obtained as one or more of intermediate output signal (not shown). Optionally, a difference between the one or more intermediate output signal and input signal 114 is obtained as one or more interim or intermediate error signal.

In some embodiments, error signal 128 with applied weight, and weighted one or more intermediate error signal, are fed back (not shown) to one or more of the layers adjusting respective coefficients such as the plurality of coefficient 376 or coefficient 396, thereby altering or adapting the output signal 120 such as reducing the error signal 128.

Without limiting, some elements that are not shown for a clarity purpose.

In some cases or embodiments, the input signal is related to the reference signal, yet the input signal is distorted such as by interference noise, that is, the input signal optionally comprises a signal related to the reference signal and an interference of a distortion, or a combination of a signal related to the reference signal and an interfering signal.

Thus, by reducing the error, or distortion, the output signal converges towards the reference signal. For example, the reference signal is a speech signal and the input signal is an echo of the speech signal with interferences of the environment, so by converging the output signal towards the uninterfered echo signal enables to cancel out the echo, at least to a certain extent.

In some cases or embodiments, the reference signal is of limited duration and/or the input signal appears with a time interval relative to the reference signal. Therefore, in some embodiments, it is sufficient, at least practically, to use a certain number of taps when using a filter such as of FIG. 2 to a steady state after some time.

The groups of taps such as group 378, and optionally the group of intermediate signals such group 394 or corresponding coefficients thereof in subsequent layers, is determined according to the characteristics reference signal 104 and/or input signal 114. For example, according to sparseness of the signals or time interval therebetween.

However, in some cases or embodiments, the time interval between the input signal and the reference signal changes, or the steady state is disrupted such as by a variation of the reference signal, and new taps and/or different coefficients have to be used to cope with the new circumstances.

Thus, having the taps in a plurality of groups such as of group 378 enables to shift or change the taps taking part in the filtering, whereas the subsequent groups such as of group 394 enable with the coefficients thereof such as of coefficient 396 to accelerate the convergence of the output signal to a steady state, or any other desired state, relative to a filter such as of FIG. 2.

As an alternative view, once a steady state is disrupted or a transition occurs, the coefficients in the subsequent groups vary until a certain group or groups in the first layer become effective in filtering, akin to a filter such as of FIG. 2, and the coefficients in the subsequent layers become practically neutral or practically a unity. Thus, in some embodiments, the coefficients of the subsequent layers may be considered as weights or significance of the filtration by the groups of taps, adaptively weighted according to the error such as by the NLMS method, where the weights vary until a steady state is reached.

For simplicity and clarity, without limiting, a dual-stage filter is described below, that is a first layer and one subsequent layer, representing optional triple-stage or quad-stage or other multiple-stage adaptive filters.

With reference back to FIG. 2 and respective description, according to some embodiments a dual-stage or dual-layer filter is disclosed, adding to a first layer as respective processor 116 an additional or a second hierarchy layer. The samples are divided in the first layer into groups and in addition to the coefficients multiplying the corresponding signal samples, the output of each group is assigned a corresponding weight in the subsequent second layer.

The N samples are divided into M groups of size L, wherein L is smaller than N. The first stage or layer comprises of summing the products of the corresponding samples and coefficients within each group of L samples to form intermediate output signal as:

$$u ( k , m ) = {\sum }_{n = 0}^{L - 1} h ( k , n ) x ( k - m L - n ) . \qquad ( Eq . 5 )$$

Further on, in the second stage, each intermediate output signal is multiplied by a coefficient as a(k,m) as a(k,0) . . . a(k,M−1), and the output signal is determined as the sum:

$$y ( k ) = {\sum }_{m = 0}^{M - 1} a ( k , m ) u ( k , m ) . \qquad ( Eq . 6 )$$

FIG. 3B is a schematic illustration of a hierarchical adaptive filter as filter 300, in accordance with the disclosure.

Filter 300 generally comprises two main blocks or stages or layers—one as filter coefficients adaptation block 304 which operates similarly to processor 116 of FIG. 2, and one as weights adaptation block 308 which assigns weights to summed groups of outputs of filter coefficients adaptation block 304.

The N samples are divided into M groups. In some exemplary embodiments, all groups comprise the same number of samples L, such that M×L=N, but other divisions can be used as well, in which each group i has its own size Lᵢ, wherein

$${\sum }_{i = 0}^{M - 1} {L}_{i} = N .$$

The algorithm employs coefficients h(k, 0) (208), h(k, 1) (220), and h(k,N−1) (236) as described in association with FIG. 2 above. Also indicated in FIG. 3 are h(k,L−1) (324), h(k, L) (328), h(k, 2*L−1) (332) and h(k,N−1)(336) which are also present in the algorithm depicted in FIG. 2 but are not indicated on the figure itself. Alternative annotation can group the weights together, such as h(k,0,0) h(k,0,1) . . . h(k,0,L₀−1) for the first block, h(k,1,0) h(k,1,1) . . . h(k,1,L₁−1) for the second block, and so on until . . . h(k, L_{M-1},0) h(k, L_{M-1},1) . . . h(k, L_{M-1}, L_{M-1}−1) for the last block.

Each sample of each group of signals is multiplied by a corresponding coefficient, and all multiplications associated with a particular group are summed. For example Σ(1)(340) sums the products of the first group and outputs u(k, 0), E(2)(344) sums the products of the second group and outputs u(k, 1), . . . Σ(M) (348) sums the products of the M-th group and outputs u(k, M−1). Thus, the output of each group is determined as follows:

$$\begin{matrix}u ( k , 0 ) = {\sum }_{l = 0}^{{L}_{0} - 1} h ( k , l ) x ( k - l ) , \\ and & ( Eq . 7 ) \\ u ( k , m ) = {\sum }_{l = 0}^{{L}_{m} - 1} h ( k , {{\sum }_{i = 0}}^{m - 1} {L}_{i} + l ) x ( k - ( {\sum }_{i = 0}^{m - 1} {L}_{i} + l ) ) \\ for m = 1 , … , M - 1. & ( Eq . 8 )\end{matrix}$$

The output of each group m is then multiplied by a corresponding weight a(k,m), such that the output y(k) is determined as follows:

$$y ( k ) = {\sum }_{m = 0}^{M - 1} a ( k , m ) u ( k , m ) . \qquad ( Eq . 9 )$$

As noted above with respect to Eq. 6, the estimated energy of the relevant sample of the x signal is determined as:

$${σ}_{x}^{2} ( k ) = \frac{1}{N} {\sum }_{n = 0}^{N - 1} {x}^{2} ( k - n ) ,$$

wherein x²(k−n) refers to the x(k−n) sample, squared.

The total energy of signal u which is the output of a particular group is:

$${σ}_{u}^{2} ( k ) = \frac{1}{M} {\sum }_{m = 0}^{M - 1} {u}^{2} ( k , m ) \qquad ( Eq . 10 )$$

wherein u²(k,m) refers to the u(k,m) sample, squared.

The h coefficients and the a weights are determined, respectively, as follows:

$$\begin{matrix}h ( 0 , n ) = 0 ; \\ h ( k + 1 , n ) = h ( k , n ) + \frac{{μ}_{x} e ( k ) x ( k - n )}{N {σ}_{x}^{2} ( k ) + {β}_{x}} \\ for n = 0 … N - 1 , \\ and & ( Eq . 11 ) \\ a ( 0 , m ) = 1 , \\ a ( k + 1 , m ) = a ( k , m ) + \frac{{μ}_{u} e ( k ) u ( k , m )}{M {σ}_{u}^{2} ( k ) + {β}_{u}} \\ for m = 0 , … M - 1 & ( Eq . 12 )\end{matrix}$$

Wherein:

N is the filter order as in NLMS, M is the number of groups or blocks and Lₘ is the length of a group or sub-block m,

μₓ and μᵤ are, respectively, step-size parameters for the filter coefficients and weights, and

βₓ and βᵤ are the regularization factors in order to prevent zero division of the normalization parts.

The weights of the adaptive filter, a(k,m), may be initially set to 1, that is, all groups are assigned the same weight, which coincides with the NLMS algorithm. However, any other initial conditions can be used as well.

In some embodiments of the disclosed two-stage filtering scheme, updating the coefficients h is done using the full filter order of N, substantially as in the NLMS algorithm. In the first stage, x(k) is filtered in M different blocks to generate intermediate signals u(k,m). In the second stage the M temporary signals u(k,m) are used as reference signals to weight adaptation block 308. Thus, u(k,m) is filtered or weighted by the secondary filter weights a(k,m) in order to refine the signal y(k). When a(k,m)=1 for all m, the proposed algorithm is equivalent to NLMS.

In some embodiments, initially or after a transition from a steady-state the a weights vary responsive to the feedback by the error signal, such as by Eq. 12, and a new steady state is approached or approximated when a(k,m)≈1 for all m, and reached when a(k,m)=1 for all m.

In an endeavor to further improve the performance of a filter relative a filter such as filter 300 of FIG. 3B, it was surprisingly found that using a different feed back scheme yielded better results in terms of increasing the convergence rate and decreasing the misadjustment level. Namely, instead of adjusting the coefficients by an overall error, such as error signal 128, the coefficients are adjusted by feeding back a weighted combination of the overall error signal and a partial error signal or error signals derived from intermediate signals such as intermediate signal 392 or intermediate signal 398 of FIG. 3A, or u(k,m) of filter 300 of FIG. 3B.

Resembling the filter 310 and filter 300 of FIG. 3A and FIG. 3B, respectively, FIG. 3C is a schematic illustration of a dual-stage or dual-layer hierarchical adaptive filter as filter 390 with weighted error feed back, in accordance with the disclosure, representing, without limiting, any number of stages or layers, and where repeated pluralities of elements are denoted by dashed lines such as line 366.

In some embodiments, an intermediate output signal 324 is obtained by summing the plurality of intermediate signal 322, and a partial error signal 326, denoted as eₚ(k), is obtained as a difference between intermediate output signal 324, denoted as yₚ(k), and input signal 114.

In some embodiments, the weights between error signal 128 denoted as e(k), and partial error signal 326 is determined by a function f_{w}(e(k),eₚ(k)) denoted as function 328, where e(k) stands for error signal 128 and eₚ(k) stands for partial error signal 326.

It is noted that f_{w} may be any function optionally operating on other signal, where f_{w} is implemented such as by an electronic circuitry and/or a program executed or executable by a processor.

In some embodiments, error signal 128 and partial error signal 326 are fed to function 328 which generates a weighted error signal 302, denoted as ea(k), and a weighted partial error signal 306, denoted as eh(k), each generated signal having a different weight or the same weight. Weighted error signal 302 is used as a feed back to adjust the weights or coefficients of filter coefficients adaptation block 304, and weighted partial error signal 306 is used as a feed back to adjust the coefficients of weights adaptation block 308

Some non-limiting examples of f_{w} are described below.

In some embodiments, f_{w} is defined as:

$${f}_{w} ( e ( k ) , {e}_{p} ( k ) ) = \{ \begin{matrix}{e}_{a} ( k ) = e ( k ) \\ {e}_{h} ( k ) = ω ( k ) \cdot {e}_{p } ( k ) + ( 1 - ω ( k ) ) e ( k )\end{matrix}$$

where the error e(k) is used for the second stage and a weighted convex combination of ep(k) and e(k) is used for the first stage according to a value ω(k) as 0<ω(k)<<1, wherein ω(k) is optionally variable or constant. It is noted that ω(k) is small relative to unity.

The second stage converges according to e(k), while the first-stage adaptive filter converges according to the a weighted sum of partial and total error. In an initial convergence or disruptions of a steady state e(k) is large relative to a steady state or convergence thereto. Therefore, since ω(k) is small relative to unity, e(k) and eh(k) are close to the overall error hence both filters converge according to the overall error.

As the overall error decreases due to the convergence process, ep(k) becomes more significant or dominant relative to e(k) in eh(k) and the coefficients of the first stage are forced to adjust to converge output signal 120 towards input signal 114, and consequently the coefficients of the second stage are adjusted towards unity.

In some embodiments, f_{w} is defined as:

$${f}_{w} ( e ( k ) , {e}_{p} ( k ) ) = \{ \begin{matrix}{e}_{a} ( k ) = e ( k ) \\ {e}_{h} ( k ) = \{ \begin{matrix}{e}_{p} ( k ) , & k = T \cdot n , n = 0 , 1 , 2 , 3 , … \\ e ( k ) , & otherwise\end{matrix}\end{matrix}$$

where the total error e(k) is used for the second stage and ep(k) and e(k) are used for the first stage in an alternating way with alternating period of T. Similarly as described above, the coefficients of first stage are forced to adjust to reduce the overall error and the coefficients of second stage are adjusted towards unity.

In some embodiments, f_{w} is defined as:

$${f}_{w} ( e ( k ) , {e}_{p} ( k ) ) = \{ \begin{matrix}{e}_{a} ( k ) = ξ \cdot e ( k ) \\ {e}_{h} ( k ) = 1 / ξ \cdot e ( k )\end{matrix}$$

where 0<ξ<1.

The coefficients of the second stage are attenuated by the value ξ and the coefficients of the first stage are amplified by 1/ξ. Once the coefficients of the second stage are attenuated the coefficients of the first stage are adjusted to operate similarly the to NLMS algorithm and the coefficients of the first-stage are adjusted towards unity. Viewed differently, the energy of the second stage is attenuated and transferred to the first stage.

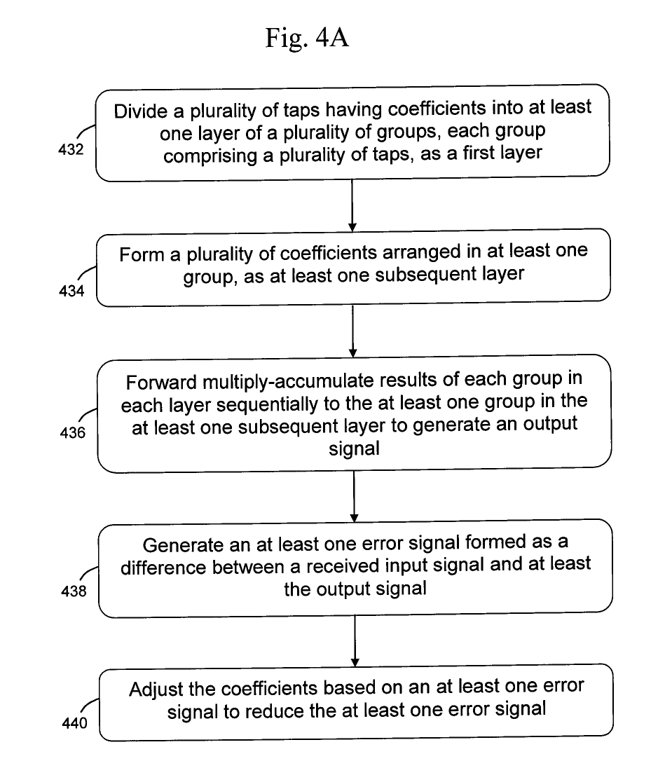

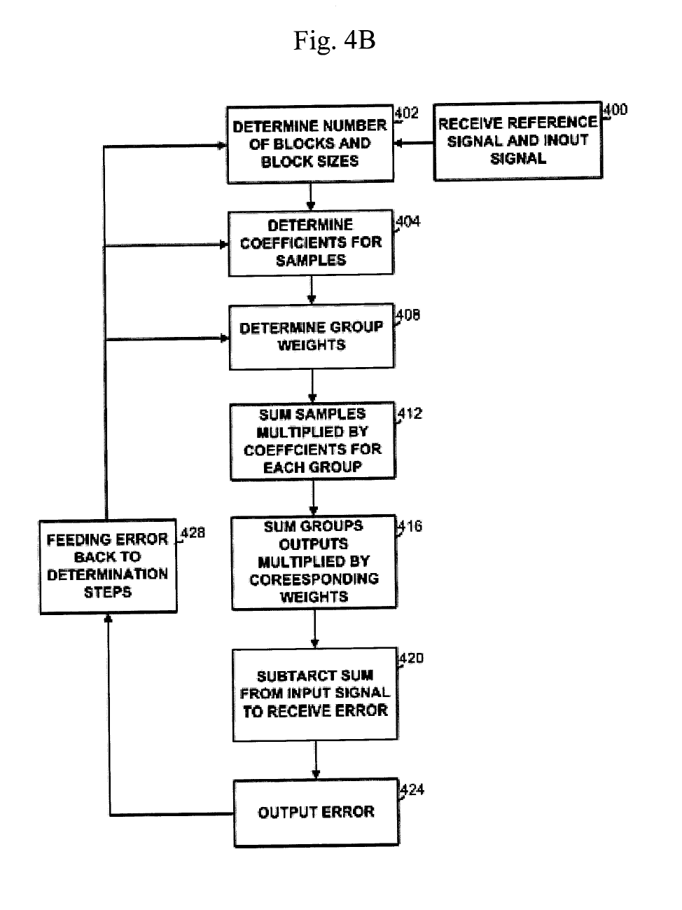

FIG. 4A is a flowchart outlining operations for a hierarchical adaptive processor, in accordance with the disclosure.

At 432 a plurality of taps having coefficients are divided into at least one layer of a plurality of groups, each group comprising a plurality of taps, as a first layer.

At 434 a plurality of coefficients arranged in at least one group, as at least one subsequent layer.

At 436 multiply-accumulate results of each group in each layer are sequentially forwarded to the at least one group in the at least one subsequent layer to generate an output signal.

At 448 an at least one error signal is generated formed as a difference between a received input signal and at least the output signal. Optionally the at least one error signal comprises at least one more error signal formed as a difference between a received input signal and at least one sum of the multiply-accumulate of each group in at least one layer.

At 440 the coefficients are adjusted based on an at least one error signal to reduce the at least one error signal.

Referring now to FIG. 4B, showing a flowchart of operations in the algorithm for implementing an adaptive processor.

On ongoing operation 400, reference signal x(k) and optionally an input signal s(k) are received. In some embodiments, a sample of each of the signals is received on each clock cycle, and that the used time window, i.e., the number of past samples considered on each cycle can be set to a constant value, or be adaptive in accordance with the resulting effect.

On group number and size determination operation 402, the number of groups or blocks M to which the reference signal samples are divided to, and the size of each group, Lᵢ for each i between 0 and M−1 are determined, based on factors such as the available processing power, required processing time, required convergence rate, keeping the energy levels of the blocks as uniform as possible as suggested in equations 7-9 below, or others considerations.

Each sample is multiplied by a corresponding coefficient h, and all products associated with a particular group are summed and then multiplied by a corresponding weight a.

In some embodiments, a division in which the number of blocks and the block sizes are the square root of the number of samples can be used. If the square root is not an integer, then the numbers can be rounded so that the product of the number of groups by the group size equals to the number of samples.

In an alternative embodiment, the number of groups and the group sizes are received from an external source or retrieved from memory rather than determined.

It will be appreciated that in some embodiments the following steps are significant only after the sample buffer is full, and the required number of samples had been received.

On coefficient determination operation 404, the h(k, 0) . . . h(k, N−1) coefficients for clock cycle k are determined, wherein h(k, 0) is the coefficient of the current sample, h(k, 1) is the coefficient of the previous sample, and so forth. The coefficients can be determined using, for example, Eq. 11 described above in association with FIG. 3B. Thus, each coefficient is associated with a particular delay of the signal.

On operation 408, the a(k, 0) . . . a(k, M−1) weights associated with each group are determined, wherein a(k, 0) is the coefficient of the first group which relates to the latest L samples of the input signal wherein L is the group size, a(k, 1) is the weight of the L samples preceding the latest L samples, and so forth. It will be appreciated that the scheme above can be modified for group sizes which vary rather than uniform ones. The coefficients can be determined using, for example, Eq. 12 described above in association with FIG. 3B.

On operation 412 each sample i of the reference signal is multiplied by the coefficient h(k, i) having the corresponding delay. Alternatively, another mathematical or logical operation can be performed between the sample and the coefficient. All products are then summed to produce the intermediate signals, indicated by u(k, i) wherein i is between 0 and the number of groups as an example can be achieved by employing Eq. 8 or Eq. 8 above.

On operation 416 the output samples associated with each group, indicated by u(k, i), are multiplied or otherwise combined with the corresponding weights a(k, i). The products are then summed or otherwise combined to generate sample of y(k) (120) signal sample, based, for example, on Eq. 9 above.

On operation 420, the sample of summed signal y(k) (120) is subtracted or otherwise compared to the corresponding sample of input signal s(k) (114) to generate a sample of error signal e(k) (128) as demonstrated by Eq. 1 above.

On operation 424 the samples of error signal e(k) (128) are output, and on optional feedback operation 428 the samples of error signal e(k) (128) are fed back to any one or more of the preceding steps: number of blocks and block size determination operation 402, coefficient determination operation 404, or operation 408 for weight determination as detailed above. Error signal e(k) (128) can be fed back as a control signal for enhancing the operation of the processor.

At least in certain cases or impediments the proposed technique outperforms the NLMS algorithm in the convergence rate, re-convergence rate and robustness to noise signal parameters, while keeping the misadjustment level intact in a multiplicity of cases.

The convergence rate is improved relatively to the prior art NLMS algorithm, since only the relevant groups receive positive weights, and due to the feedback of error e(k) the weights are further amplified. This is particularly relevant for sparse systems, such as line or electrical echo canceller, in which the relevant groups will get higher weights, thereby reducing the overall weight misadjustment noise without harming the system convergence rate.

Some enhancements can be implemented for the disclosed weighted adaptive algorithm. For example, in order to accelerate the reaction of the algorithm to echo path change, e.g., when a speaker changes his location relatively to the microphone which requires re-convergence of the algorithm, the adaptive weights a(k,m) can be regulated in the following manner:

a(k, m)=max(a(k, m),δ) wherein δ is a regulating factor, whose value can change according to the system state, e.g., initial convergence, double talk, re-convergence, or other conditions. This regulation is particularly useful where a*h is a constant, in which case this limitation will disable extreme values of a or h.

In another enhancement, the lengths of the groups or blocks length can be chosen arbitrarily, and not necessarily be equal. For example, the group lengths can be so as each block maintains the same energy level E, i.e.,

$$\begin{matrix}{a}^{2} ( k , 0 ) {\sum }_{l = 0}^{{L}_{0} - 1} {‖ h ( k , l ) ‖}^{2} = E for m = 0 \\ and & ( Eq . 13 ) \\ {a}^{2} ( k , m ) {\sum }_{l = 0}^{{L}_{m} - 1} {‖ h ( k , {{\sum }_{i = 0}}^{m - 1} {L}_{i} + l ) ‖}^{2} = E \\ for m = 1 … M - 1 \\ and therefore & ( Eq . 14 ) \\ E = \frac{1}{M} [ {{\sum }_{m = 0}}^{M - 1} {a}^{2} ( k , m ) {\sum }_{l = 0}^{{L}_{m} - 1} {‖ h ( k , {{\sum }_{i = 0}}^{m - 1} {L}_{i} + l ) ‖}^{2} ] & ( Eq . 15 )\end{matrix}$$

Solving the above equation system provides the values of the block lengths, Lᵢ.

It will be appreciated that the above disclosure relates also to an adaptive processor for estimating a reference signal, the adaptive processor comprising a component for receiving or determining a number of groups and respective group sizes, each group associated with a predetermine range of delay values of the reference signal; a component, such as a control component for determining a multiplicity of coefficient, each coefficient associated with a predetermined delay of the reference signal; a component, such as a control component for determining a multiplicity of weights, each weight associated with one of the groups; a set of delays, which can be implemented as memory components for storing previous samples of the reference signal; a first set of adaptive filters for multiplying each sample of the reference signal having a delay by a corresponding coefficient to obtain a first product; a first set of adders for summing the multiplicity of first products associated with each group into a group sum signal sample; a second set of adaptive filters for multiplying each group sum signal sample by a weight associated with the group to obtain a second product; and a second adder for summing all second products to obtain an estimated signal value.

In some embodiments, the disclosed technique is implemented in a variety of devices, including firmware ported for a specific processor such as digital signal processor (DSP) or microcontrollers, or can be implemented as hardware or configurable hardware such as field programmable gate array (FPGA) or application specific integrated circuit (ASIC).

Optionally or additionally, the disclosed technique is implemented as software, for example, interrelated sets of computer instructions, arranged as executables, libraries, web pages, portals or other units designed to be executed by a computing platform such as a general purpose computer, a personal computer, a mainframe computer, a server, a mobile device, or any other type of computing platform provisioned with a memory device, a CPU or microprocessor device, and I/O ports.

It will be appreciated that although part of the disclosure was related in an exemplary way to NLMS processors, it is not limited to such and can be used with any known processor type, including but not limited to least-mean squares (LMS), normalized LMS (NLMS), proportionate NLMS (PNLMS), block NLMS (BNLMS), multi-delay adaptive filtering (MDAF), recursive least squares (RLS), fast RLS (FRLS) or extensions thereof.

It will also noted that an enhancement of the method and algorithm can use more than the two levels described, and introduce further levels.

It will be appreciated that multiple implementations and variations of the method and algorithm can be designed. Various considerations and alternatives thereof can be considered for determining the number of blocks and the block sizes, the coefficients and the weights.

Some examples for demonstrating the performance of a dual-stage filter with a feed back of weighted combination of overall error signal and partial error signal, such as filter 390 of FIG. 3C, are discussed below.

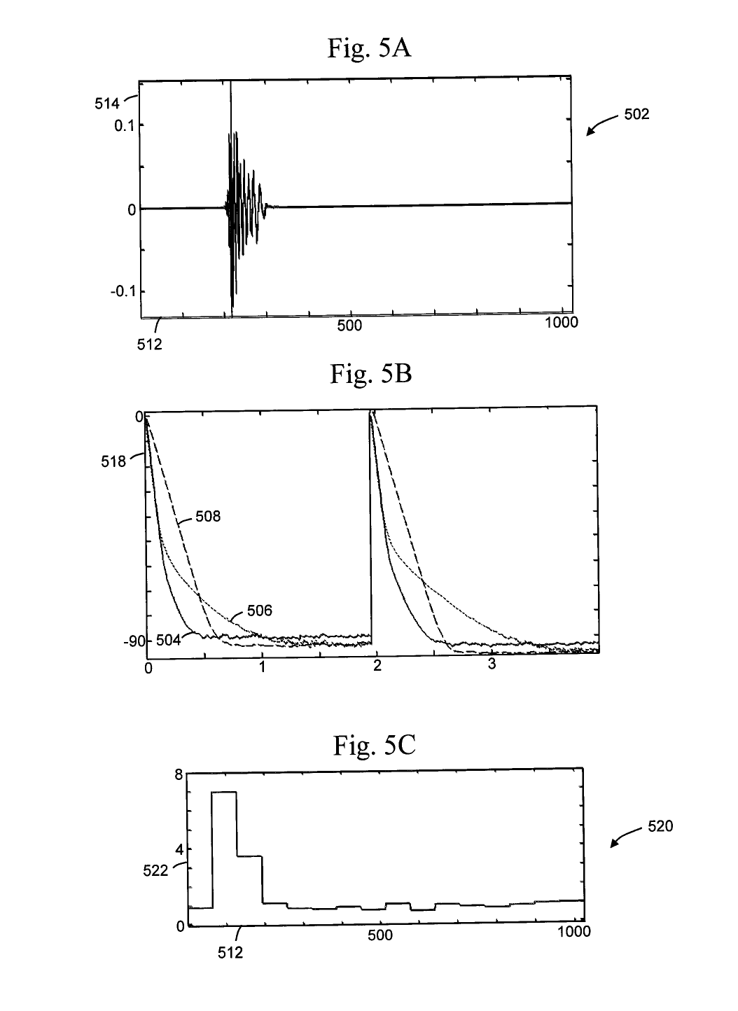

FIG. 5A illustrates an echo path 502 as a sparse impulse response, where the horizontal axis 512 is in number of taps and the vertical axis 514 is in dB.

FIG. 5B illustrates simulation of convergence and tracking 504 of a hierarchical adaptive filter with weighted error feed back in the case of white Gaussian noise as related to echo path 502 of FIG. 5A, in accordance with the disclosure.

The horizontal axis 516 illustrates the number of iterations in 10⁵ and the vertical axis 518 illustrates the misalignment in dB between an echo path such as echo path 502 and the estimated echo path yielded by a filter such as filter 390.

As a comparison, FIG. 5B also illustrates a convergence 506 of a PLMNS filter and a convergence 508 of a NLMS filter.

The initial state is at iteration 0, and a disruption occurred at about 2×10⁵ iterations.

It is noted that though the initially the convergence 506 is similar to PNLMS, yet unlike PNLMS the convergence speed is maintained until steady state, and no re-convergence problems are observed.

FIG. 5C illustrates the distribution of weights, or coefficients, in a steady state of a second stage of a hierarchical adaptive filter with weighted error feed back such as filter 390, in accordance with the disclosure.

The horizontal axis 512 is in number of taps and the vertical axis 522 shows the weights values.

It is noted that due to the sparseness of echo path 502, the significant weights are distributed in a limited range between about 50^{th} tap to 150^{th} tap, with the largest values at about the 100^{th} tap, as the active part of the weights, while the rest of the values are about 1 or close to unity.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation, material, step of component to the teachings without departing from the essential scope thereof. Therefore, it is intended that the disclosed subject matter not be limited to the particular embodiment disclosed as the best mode contemplated for carrying out this disclosure, but only by the claims that follow.

1. A method for filtering a reference signal by a series of taps correspondingly having first coefficients, comprising:
dividing the taps into at least one layer of a plurality of groups, each group comprising a plurality of taps, as a first layer;
forming a plurality of second coefficients arranged in at least one group, as at least one subsequent layer; and
forwarding multiply-accumulate results of each group in each layer sequentially to the at least one group in the at least one subsequent layer, generating an output signal.

2. The method for filtering a reference signal by a series of taps correspondingly having first coefficients according to claim 1, further comprising adjusting the first coefficients and the second coefficients based on an error signal formed as a difference between the output signal and a received input signal that comprises a signal related to the reference signal and an interference.

3. The method for filtering a reference signal by a series of taps correspondingly having first coefficients according to claim 2, wherein by adjusting the first coefficients and the second coefficients the output signal converges towards the signal related to the reference signal.

4. The method for filtering a reference signal by a series of taps correspondingly having first coefficients according to claim 2, wherein adjusting the first coefficients and the second coefficients comprises adjusting the first coefficients and second coefficients based on the error signal and an at least one interim error signal formed as a difference between the received input signal and a summation of the multiply-accumulate results of at least one layer.

5. The method for filtering a reference signal by a series of taps correspondingly having first coefficients according to claim 4, wherein based on the error signal and the at least one interim error signal comprises based on weighted said error signal and said at least one interim error signal.

6. The method for filtering a reference signal by a series of taps correspondingly having first coefficients according to claim 1, wherein the at least one subsequent layer comprises one subsequent layer.

7. The method for filtering a reference signal by a series of taps correspondingly having first coefficients according to claim 6, comprising:
sampling the reference signal by consecutive time delays into a plurality of samples;
holding and dividing the samples sequentially forming a plurality of sequential groups, each group comprising a plurality of the samples;
multiplying the samples in each group by determined corresponding first coefficients, yielding products, and summing the products thereby generating a plurality of intermediate signals;
multiplying the plurality of intermediate signals by determined corresponding second coefficients generating the output signal.

8. The method for filtering a reference signal by a series of taps correspondingly having first coefficients according to claim 7, further comprising:
obtaining an error signal formed as a difference between the output signal and a received input signal related to the reference signal and distorted by an interference; and
based on the error signal adjusting said first coefficients and second coefficients thereby converging the output signal towards the signal related to the reference signal.

9. The method for filtering a reference signal by a series of taps correspondingly having first coefficients according to claim 7, further comprising:
obtaining a first error signal as a difference between the output signal and the output signal and a received input signal related to the reference signal and distorted by an interference, and an interim error signal as a difference between a summation of the plurality of intermediate signals and the received input signal; and
based on weighted said first error signal and said interim error signal adjusting said first coefficients and second coefficients thereby converging the output signal towards the signal related to the reference signal.

10. The method for filtering a reference signal by a series of taps correspondingly having first coefficients according to claim 7, wherein the plurality of sequential groups is determined according to at least one of the received input signal or the reference signal.

11. An electronic apparatus comprising a processor operable according to a program stored in a computer-readable medium, wherein the program is configured for filtering a reference signal by a series of taps correspondingly having first coefficients by operations comprising:
dividing the taps into at least one layer of a plurality of groups, each group comprising a plurality of taps, as a first layer;
forming a plurality of second coefficients arranged in at least one group, as at least one subsequent layer; and
forwarding multiply-accumulate results of each group in each layer sequentially to the at least one group in the at least one subsequent layer, generating an output signal.

12. The electronic apparatus according to claim 11, wherein the operations further comprise adjusting the first coefficients and the second coefficients based on an error signal formed as a difference between the output signal and a received input signal that comprises a signal related to the reference signal and an interference.

13. The electronic apparatus according to claim 12, wherein by adjusting the first coefficients and the second coefficients the output signal converges towards the signal related to the reference signal.

14. The electronic apparatus according to claim 12, wherein adjusting the first coefficients and the second coefficients comprises adjusting the first coefficients and second coefficients based on the error signal and an at least one interim error signal formed as a difference between the received input signal and a summation of the multiply-accumulate results of at least one layer.
